(19) United States
(12) Patent Application Publication
(10) Pub. No.: US 2014/0019237 A1
(43) Pub. Date: Jan. 16, 2014

(54) SYSTEM AND METHOD FOR PRESCRIBER-CENTRIC TARGETING

(71) Applicant: Chad Nathaniel GOTTFRID, Worcester, PA (US)

(72) Inventor: Chad Nathaniel GOTTFRID, Worcester, PA (US)

(73) Assignee: Catalina Marketing Corporation, St. Petersburg, FL (US)

(21) Appl. No.: 13/546,511

(22) Filed: Jul. 11, 2012

(51) Int. Cl. G06Q 30/02

(52) U.S. Cl. 705/14.52; 705/14.49

(57) ABSTRACT

A system and method for prescriber-centric targeting may use information known about prescribers to determine patients who should be targeted to receive information relating to a target drug. The system may identify a prescriber based on a propensity of the prescriber to prescribe the target drug or a drug in the same class as the target drug. The system may identify a patient based on the identified prescriber. For example, the patient may be a former or current patient of the prescriber. The system may cause the information relating to the target drug to be communicated to the patient. By identifying prescribers based on their propensity to prescribe a target drug and then targeting their patients, the system may obtain higher rates of prescription fills for the target drug while at the same time providing more relevant information to the patients.

### FIELD OF THE INVENTION

The invention relates generally to targeting an audience to receive messages and more particularly to a system and method for prescriber-centric targeting that uses data known about prescribers to identify patients who are to receive information relating to target drugs.

### BACKGROUND OF THE INVENTION

Generally speaking, pharmaceutical companies and others research and develop formulations for the purpose of developing a new drug. Once approved for use, the new drug is typically marketed to the public and prescribers using a brand name. The pharmaceutical company is typically given a period of exclusivity, where other manufacturers may not sell the brand drug until after such period has expired. Upon expiration of the exclusivity period, other manufacturers may begin to sell competing drugs called generic drugs with the same or similar active ingredient(s) as the brand drug, creating competition for the brand drug. Typically, patients may choose a generic even if their prescriber has prescribed a brand drug equivalent (occasionally an insurance carrier mandates use of generics; sometimes a prescriber writes a specific instruction to fill with a brand instead of generic, to which the pharmacy must oblige).

The brand drug may be classified into a drug class (also referred to herein as “class of drugs”), which may include drugs treating the same or similar condition as the brand drug. A class of drugs may include other brand drugs (each having different active ingredient(s) and having once been a new drug) and generics of those brand drugs.

Pharmaceutical companies may wish to market their new drug during the exclusivity period and afterward when competition with generics may reduce margins. Conventionally, pharmaceutical companies market their brand drug (hereinafter “target brand”) by non-specific advertising to a wide audience. However, non-specific advertising mostly targets those who have no need for the target brand and results in poor returns. In some conventional systems, attributes of patients may be used to market the target brand to the patient. However, in these systems, appropriate patients may not be identified because their prescribers may be unfamiliar or uncomfortable with the target brand. As such, these targeting efforts may not result in a prescription fill.

Thus, what is needed is to reach appropriate audiences and improve the likelihood of a marketing campaign resulting in a prescription fill for a target brand, thereby improving return on investment in the marketing campaign. These and other drawbacks exist.

### SUMMARY OF THE INVENTION

The invention addressing these and other drawbacks relates to a system and method for prescriber-centric targeting that uses data known about prescribers to identify patients who are to receive information relating to target drugs (such as target brands or target generics, etc.). The system and method may be adapted to execute a marketing program that promotes a target drug or may simply identify and provide a list of patients who should receive the information relating to the target drug. A pharmaceutical company or others may use the invention to identify patients who may be suitable to receive information relating to the target brand. The purpose of the information may be to encourage the patient to ask their prescriber whether the target brand is appropriate for their use. Instead of non-specific advertising or identifying targets based on patient attributes alone, the system and method may identify prescribers who may have a propensity to prescribe the target brand.

The identification and determined propensities may be based on a prescriber profile that indicates a prior behavior or includes other attributes of the prescriber. For example, the system and method may determine a prescription history of the prescriber to identify a number of instances in which the prescriber has prescribed the target brand or drugs belonging to the drug class to which the target brand belongs (hereinafter “target class”). Based on the identity of the prescriber, the system and method may determine patients who should be targeted. For example, the system and method may determine a relationship between the prescriber and the patient. In particular, patients of the identified prescriber may be identified for targeting. By targeting patients of prescribers who have a propensity to prescribe the target brand or drugs in the target class, the system and method may be configured to find suitable targets for a marketing campaign that promotes the target drug.

In an embodiment, the system and method may determine a number of times that a prescriber has prescribed the target drug or a drug in the target class. Based on the number, the prescriber may be identified to serve as a basis for identifying patients who may be suitable to receive the information relating to the target drug. For example, when the number meets or exceeds a threshold number, the prescriber may be identified to serve as the basis for identifying patients. The threshold number may be configurable by the pharmaceutical company or others. The threshold number may be configurable for each target brand being promoted.

In an embodiment, the number may be compared to a total number of prescriptions written by the prescriber such that a ratio is determined. Based on the ratio, the prescriber may be identified to serve as the basis for identifying patients who may be suitable to receive the information relating to the target brand. For example, when the ratio meets or exceeds a threshold ratio, the prescriber may be identified to serve as the basis for identifying patients. The threshold ratio, like the threshold number, may be configurable by the pharmaceutical company or others and may be configurable for each target drug being promoted.

In an embodiment, patients of the prescriber may be determined based on prior prescription records that indicate that the patient was previously written a prescription by the prescriber. In an embodiment, other information sources that indicate a prescriber-patient relationship may be used as well.

In an embodiment, when patients of the prescriber have been identified, they may be filtered based on qualifying criteria. The criteria may be configured by the pharmaceutical company or others and may be configurable for each target brand. For example, a patient may be filtered out of a pool of identified patients based on whether that patient filled a brand drug within a threshold period, which may be configurable by the pharmaceutical company or others and may be configurable for each target brand. As such, the system and method may build a patient profile using information known about the patient including prescription histories, household purchases, demographic information, and/or other profile information of the patient. The criteria may be configured to filter out the patient using any of the information available in the patient profile.

In an embodiment, prescribers and/or patients may be ranked based on their profiles. For example, the system and method may select the top-ranking prescribers and/or filter out low-ranking patients for targeting. In this embodiment, targeting may be limited to high-quality, high probability outcomes.

The invention may be configured for additional applications as well. For example, the system and method are not limited to marketing target brands and may be configured to promote generics and non-prescription (e.g., over-the-counter) drugs or other items that may be promoted based on the prescriber profile. The invention may also be configured to survey prescribers generally without regard to a particular target brand in order to determine, for example, prescription trends. Pharmaceutical companies and others may use such trend data to determine which drugs/brands should be marketed more or less (or the same). As such, embodiments describing the identification of patients to market a target drug based on prescriber behavior is exemplary in nature and should not be viewed as limiting.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 depicts an exemplary system architecture for prescriber-centric targeting, according to an aspect of the invention.

FIG. 2 illustrates an exemplary prescriber-centric targeting engine, according to an aspect of the invention.

FIG. 3 is an exemplary illustration of a process for prescriber-centric targeting, according to an aspect of the invention.

FIG. 4 illustrates an exemplary prescriber profile chart, according to an aspect of the invention.

FIG. 5 illustrates an exemplary organic conversion chart, according to an aspect of the invention.

FIG. 6 illustrates an exemplary program size chart, according to an aspect of the invention.

### DETAILED DESCRIPTION OF THE INVENTION

Various aspects of the invention described herein are directed to a system and method for prescriber-centric targeting. Information relating to a target drug or a drug class (e.g., a class of drugs that is related to the drug) may be targeted to patients who may benefit from or otherwise ask their prescriber (e.g., doctor, physician assistant, registered nurse, or other who may write prescriptions) whether the drug or drug class is suitable for them. The information may include a promotion such as a coupon, information describing the drug (e.g., uses, dosages, indications, contra-indications, etc.), and/or other information that provides an incentive and/or educational information to the patient.

Rather than using a non-targeted commercial to the general public or only information known about the patient for targeting, the system and method for prescriber-centric targeting uses information known about prescribers to determine patients who should be targeted. For example, patients of a first prescriber who has prescribed a particular brand of drug may be more likely to be prescribed that particular brand of drug than patients of a second prescriber who has never prescribed that particular brand. In the foregoing example, the first prescriber may be more likely to prescribe the particular brand when asked by her patient. Thus, information relating to the target drug may be more effective when presented to patients of the first prescriber than to patients of the second prescriber. By understanding and profiling the foregoing example as well as other prescriber attributes and behavior, the system and method may identify patients who should be targeted to receive the information relating to the drug or the drug class based on an identification of prescribers.

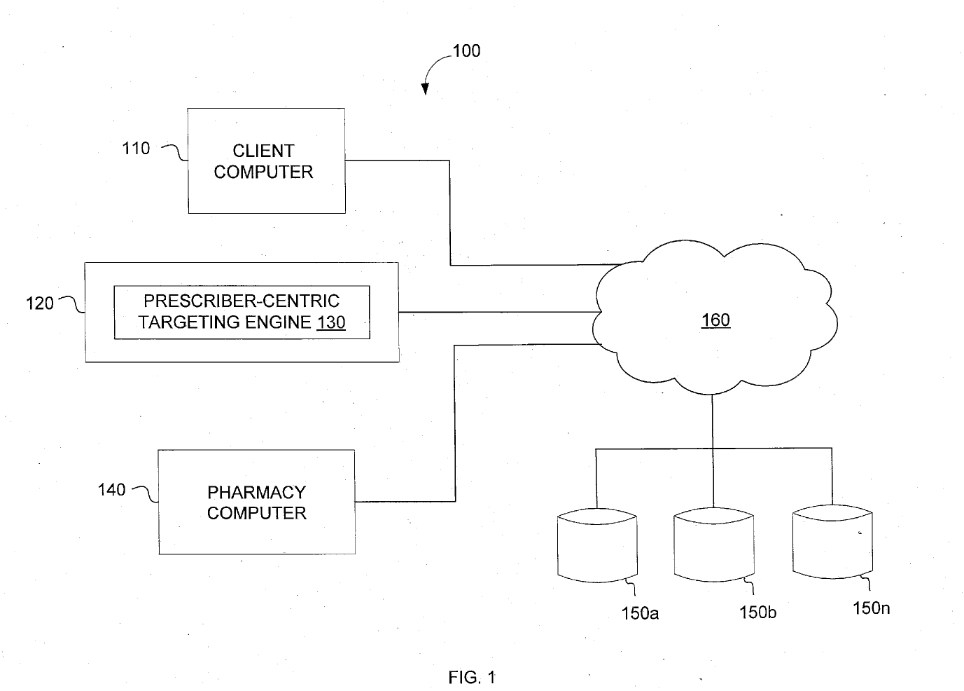

FIG. 1 depicts an exemplary system architecture 100 for prescriber-centric targeting, according to an aspect of the invention. Computer 120 may comprise one or more computing devices configured with a prescriber-centric targeting engine 130 (also referred to herein as “targeting engine 130”) that enables the various features and functions of the invention, as described in greater detail below.

Those having skill in the art will recognize that computer 120 may comprise a processor, one or more interfaces (to various peripheral devices or components), memory, one or more storage devices, and/or other components coupled via a bus. The memory may comprise random access memory (RAM), read only memory (ROM), or other memory. The memory may store computer-executable instructions to be executed by the processor as well as data that may be manipulated by the processor. The storage devices may comprise floppy disks, hard disks, optical disks, tapes, or other storage devices for storing computer-executable instructions and/or data.

One or more applications, including targeting engine 130, may be loaded into memory and run on an operating system of computer 120. In one exemplary implementation, computer 120 may comprise a server device, a desktop computer, a laptop, a cell phone, a smart phone, a Personal Digital Assistant, a pocket PC, or other device.

Network 160 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), or other network.

Client computer 110 may include a desktop computer, a laptop, a cell phone, a smart phone, a Personal Digital Assistant, a pocket PC, or other device that a patient may use to receive the information relating to the target drug or the drug class. For example, computer 120 may cause the information relating to the drug or the drug class to be communicated by electronic mail, voice call, Short Message Service (SMS) text messaging, the Internet (e.g., via a web page), social networks, etc.

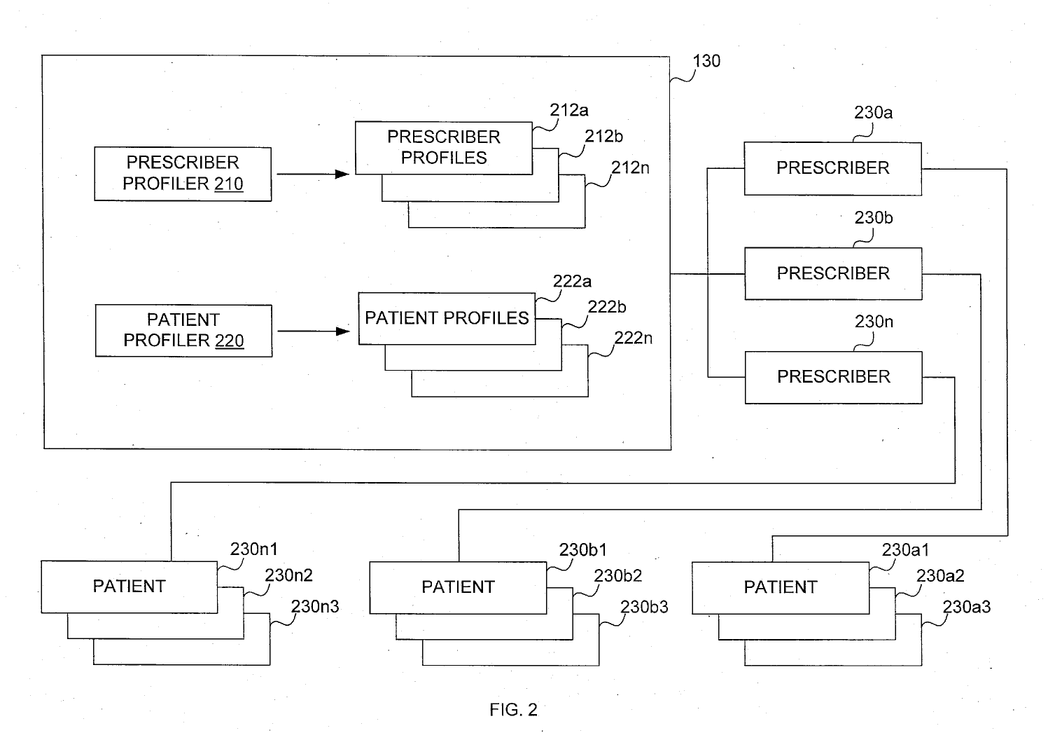

Client computer 110 may include a computing device used by a marketer (such as a pharmaceutical company or its representatives) to input information relating to the target brand. In other words, the marketer may use client computer 110 to connect with system 100 to input a marketing campaign that promotes the target brand. The marketer may input various criteria and parameters associated with identifying prescribers and/or patients, as described in more detail with respect to FIG. 2. In an embodiment, client computer 110 may include a computing device used by a prescriber or patient to enter profile information or otherwise interact with the system.

Pharmacy computer 140 may include a server device, a desktop computer, a laptop, or other device used for pharmacy operations. Pharmacy computer 140 may store prescription records in a prescription records database, to which computer 120 has access. In one embodiment, a prescription record includes an identification of the prescriber who wrote the prescription, an identification of a drug, and an identification of a patient, which may be de-identified or otherwise encrypted. It should be noted that operations and features described herein may function with a de-identified patient identifier. In other words, in an embodiment, an actual identification of a patient need not be known as long as a unique de-identified patient identifier can be obtained.

In one embodiment, the information relating to the drug or the drug class may be communicated to the patient via pharmacy computer 140. For example, computer 120 may cause the information relating to the drug or the drug class to be communicated via pharmacy computer 140 in the form of a receipt, a pamphlet, a brochure, or other printed material to be given to the patient at the pharmacy. Such material may also be communicated to the patient electronically using a wired or wireless connection (e.g., BLUETOOTH, ZIGBEE, etc.) between pharmacy computer 140 and a user device.

It should be recognized that any database generally referenced herein may comprise one or more of databases (150a, 150b, . . . , 150n) or other storage devices. Additionally, any data or information described as being stored in a database may be stored locally on computer 120.

The foregoing description of the various components comprising system architecture 100 is exemplary only, and should not be viewed as limiting. The invention described herein may work with various system configurations. Accordingly, more or less of the aforementioned system components may be used and/or combined in various implementations.

Having provided a non-limiting overview of exemplary system architecture 100, the various features and functions enabled by targeting engine 130 (vis-à-vis various system components) will now be explained.

FIG. 2 illustrates an exemplary prescriber-centric targeting engine 130, according to an aspect of the invention. Targeting engine 130 may comprise various modules that may enable the features and functionality and implement the various methods (or algorithms) described in detail herein. Generally speaking, through various modules, targeting engine 130 obtains prescriber information and may generate prescriber profiles (212a, 212b, . . . , 212n), Based on the prescriber profiles 212, various prescribers (230a, 230b, . . . , 230n) may be identified to serve as the basis for targeting patients to receive information relating to a target drug. Targeting engine 130 may determine patients (242a, 242b, . . . , 242n), patients (244a, 244b, . . . , 244n), and patients (246a, 246b, . . . , 246n) based on prescribers (230a, 230b, . . . , 230n) who will receive the information. In an embodiment, targeting engine 130 may use prescriber profiles 212 in combination with patient profiles (222a, 222b, . . . , 222n) to target patients to receive the information relating to the target brand.

In an embodiment, targeting engine 130 may include a prescriber profiler 210 that generates the prescriber profiles, which may be used to identify a prescriber to serve as the basis for targeting patients to receive information relating to a drug or a class of drugs.

In an embodiment, prescriber profiler 210 may identify drugs and drug classes that are prescribed by the prescriber. Drugs and drug classes prescribed by a prescriber may indicate the prescriber's knowledge of and propensity to prescribe a target brand. Furthermore, drugs and drug classes filled by a prescriber's patients (determined from prescription records) may indicate a propensity of the prescriber's patients to fill brand drugs over generics in a given drug class when prescribed brand drugs (this may indicate the prescriber's tendency to recommend a brand over a generics, for example, or simply that the prescriber's patients tend to prefer brand over generics). The foregoing information may therefore be useful when targeting patients to receive promotional or other incentivizing messages about target drugs.

In an embodiment, prescriber profiler 210 may obtain prescription records, which may be stored in the prescription records database, to determine the drugs and drug classes prescribed by the prescriber. For example, from the prescription record, prescriber profiler 210 may determine a prescriber identifier such as a Drug Enforcement Agency number and a drug identifier such as a National Drug Code. Also from the prescription record, or based on queries to a drug database, prescriber profile 210 may determine a class of drugs to which the drug from the prescription record belongs. In this manner, prescriber profiler 210 may determine a drug and a drug class that was prescribed by the prescriber. Prescriber profiler 210 may repeat this process for multiple prescription records, building a historical profile of drugs and drug classes prescribed by various prescribers.

In an embodiment, prescriber profiler 210 may determine a number of instances in which the prescriber has prescribed the drug or a drug in the drug class. Prescriber profiler 210 may use the number to identify the prescriber to serve as a basis for targeting. In one embodiment, the prescriber is identified when the number meets or exceeds a threshold number. For example and without limitation, targeting engine 130 may identify prescribers who prescribed at least one of the drug or a drug in the class of drugs.

In one embodiment, prescriber profiler 210 may determine a ratio of the number with a total number of a plurality of prescriptions prescribed by the prescriber comprising the drug, the drug class and other drugs. The ratio represents the proportion of prescriptions of the drug or the drug class prescribed by the prescriber in relation to the total number of prescriptions of all drugs prescribed by the prescriber. In an embodiment, a higher ratio indicates a higher probability that the prescriber will prescribe the target drug. Thus, patients associated with high ratio prescribers may be candidates to receive information relating to the drug or the drug class.

In an embodiment, the prescriber is identified when the ratio meets or exceeds a predefined ratio. For example and without limitation, targeting engine 130 may identify prescribers whose ratio is above 10% to serve as a basis for targeting.

In an embodiment, prescribers may be ranked based on the number of prescriptions written for the drug and/or based on the ratio. For example, targeting engine 130 may identify prescribers having the highest numbers and/or highest ratios.

In an embodiment, prescriber profiler 210 may determine a specialty of a prescriber. For example, prescriber profiler 210 may determine the specialty based on online bios, social media sites, prescription writing patterns (e.g., prescriptions consistent with a specialty in psychiatry), databases that describe prescribers, and/or other sources of information that may indicate a specialty of the prescriber. Based on the specialty, targeting engine 130 may identify the prescriber to serve as the basis for targeting. For example, when marketing a particular brand of anti-psychotic drug, targeting engine 130 may identify prescribers having a specialty in psychiatry.

In an embodiment, targeting engine 130 may determine a patient to be targeted based on the identified prescriber. In one embodiment, targeting engine 130 may determine the patient to be targeted based on a relationship between the patient and the prescriber. The relationship may include a current or former prescriber-patient relationship. A current or former patient of a prescriber who has a prescribed a target drug or a drug in the same drug class as the target brand (as determined by the prescriber profiler) may be a good candidate to target when promoting the target drug. The relationship may be determined using information available to targeting engine 130. For example, targeting engine 130 may determine that the patient is a former or current patient of the prescriber based on prior prescription records. An existence of a prescription prescribed by a prescriber for a patient may indicate that that was a patient-prescriber relationship. Targeting engine 130 may determine that the patient is a former patient of the prescriber if there is a more recent prescription record for the patient with another prescriber who shares the same field of medicine as the prescriber.

In an embodiment, the relationship may include a shared insurance network. For example, a prescriber may be included in a provider network of an insured patient. In this embodiment, a patient need not be a current or former patient of the prescriber to be determined to receive the information relating to the target drug. In this example, the information may include an identity of the prescriber and an indication that the prescriber is an in-network provider so that the patient is made aware of the target drug and also of a prescriber who may prescribe the target drug. As such, targeting engine 130 may target patients who may begin a prescriber-patient relationship in response to the information relating to the target drug and the information relating to the prescriber.

In an embodiment, targeting engine 130 may use the prescriber profiles in combination with information known about potential patients who may receive the information relating to the target brand. For example, targeting engine 130 may include a patient profiler 220 that generates patient profiles (222a, 222b, . . . , 222n), which may be used in combination with prescriber profiles (212a, 212b, . . . , 212n) to determine which patients should be targeted to receive the information relating to the target brand.

In an embodiment, targeting engine 130 may compare the patient profiles to various criteria to filter or rank patients in a pool of target patients such as patients (242a, 242b, . . . , 242n) that were determined based on the identity of a prescriber such as prescriber 230a. In an embodiment, the criteria may be unique to a particular marketing campaign, a particular target drug, and/or a drug class. Such criteria may be entered by a marketer or others who may manage a marketing campaign.

In an embodiment, patient profiler 220 may review prescription records to determine a history of prescription drugs and/or classes of those prescription drugs in order to assess the prescription fill history of a patient.

In an embodiment, a criterion may include whether the patient has a propensity to fill brand drugs versus generics. For example, for a given prescription of the patient, patient profiler 220 may determine whether the prescribed drug is a brand drug and if so, whether there exists a generic equivalent. If a generic equivalent exists and the brand drug was filled, this may indicate a propensity to fill brand drugs versus generics.

In an embodiment, targeting engine 130 may remove from the pool of target patients (242a, 242b, . . . , 242n) a patient with a low propensity to fill brand drugs or may assign a lower rank to the patient.

In an embodiment, a criterion may include whether the patient filled at least one prescription in a class of drugs to which the target brand belongs within a threshold period (e.g., within the latest six months). Targeting engine 130 may remove a patient from the pool of target patients (242a, 242b, . . . , 242n), if the patient profile indicates that the patient has not filled at least one prescription in the class of drugs within the threshold period.

In an embodiment, the patient profile and criteria are not limited to prescription records. Patient profiler 220 may use other information about the patient to which the profiler has access. For example, patient profiler 220 may use information such as over-the-counter drug purchases, household purchases, demographic information, and/or other marketing-related information that may be known about the patient in order to further refine the various pools of target patients that were identified based on prescriber identities (which were in turn identified based on prescriber profiles).

It should also be noted that the various profiles (e.g., prescriber profiles and/or the patient profiles) may include information from prescribers and patients. For example, the various profiles may include responses to questionnaires, profiles created by patients and/or prescribers, or other information provided by prescribers and/or patients. Thus, in an embodiment, any of the various profile information may be determined automatically from information sources and/or may be provided by the prescriber or patient.

In an embodiment, the various profiles may be generated on-demand (e.g., dynamically in response to a request) and/or be pre-computed periodically. The various profiles may also be stored in a profile database, which may be updated as appropriate.

In operation, targeting engine 130 may be used in various configurations. In one configuration, for example, targeting engine 130 may be used to identify prescribers for the purpose of marketing a particular target drug. In this configuration, targeting engine 130 may determine prescriber profiles with respect to that target drug and target class. Targeting engine 130 may search for prescribers who have a propensity to prescribe the target drug or at least prescribe drugs in the target class.

In another configuration, targeting engine 130 may be used to identify which brands should be targeted. In this configuration, targeting engine 130 may identify prescribers who prescribe drugs in a particular drug class. This information may be useful for various drug manufacturers who may wish to target patients associated with prescribers who actively prescribe a particular class of drugs in order to begin, sustain, reduce, or enhance a marketing campaign directed to those patients.

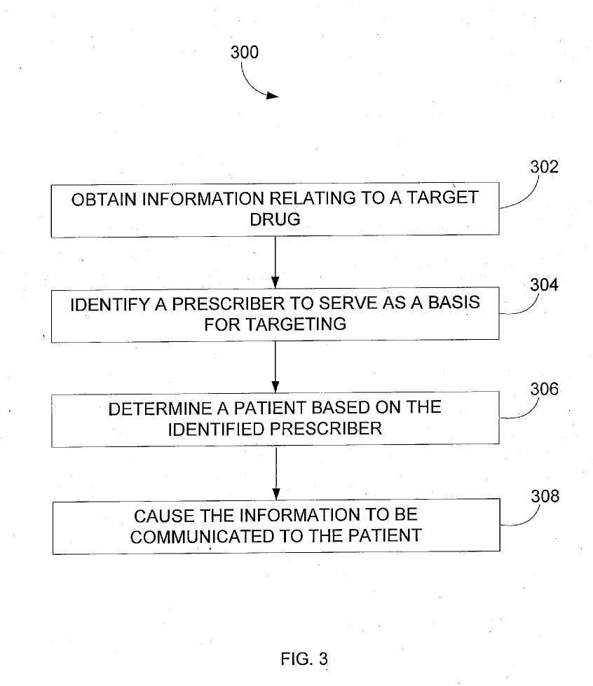

FIG. 3 is an exemplary illustration of a process 300 for prescriber-centric targeting, according to an aspect of the invention. The various processing operations and/or data flows depicted in FIG. 3 (and in the other drawing figures) are described in greater detail herein. The described operations may be accomplished using some or all of the system components described in detail above and, in some embodiments, various operations may be performed in different sequences. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 302, process 300 may include obtaining information relating to a target drug. For example, computer 130 may implement a marketing campaign for the target drug and may be provided with information (e.g., coupons, brand information, dosing, uses, etc.) relating to the target drug. The information may be stored in a marketing campaign database, from which computer 130 may obtain the information.

In an operation 304, process 300 may include identifying a prescriber to serve as a basis for targeting one or more patients to receive the information relating to the target drug. For example, computer 130 may determine prescriber profiles for various prescribers. The prescriber profiles may indicate a propensity of the prescribers to prescribe the target drug or at least prescribe drugs in the same drug class of the target drug. Based on the prescriber profiles, computer 130 may identify prescribers to serve as the basis for targeting one or more patients to receive the information.

In an operation 306, process 300 may include determining a patient based on the identified prescriber. For example, computer 130 may determine a relationship between the patient and the identified prescriber. In a particular example, patients of the prescriber may be targeted to receive the information relating to the target drug. Instead of targeting a broad audience or using patient characteristics alone for marketing the target drug, computer 130 may target patients of prescribers who have a propensity to prescribe the target drug. In some embodiments, only patients meeting certain qualifying criteria will be targeted. In these embodiments, computer 130 may filter out patients who have a relationship with the identified prescribers based on the qualifying criteria.

In an operation 308, process 300 may include causing the information relating to the target drug to be communicated to the patient. By way of example, computer 130 may cause pharmacy computer 140 to print the information for communication to the patient at the pharmacy during the identified patient's next visit to the pharmacy. In another example, computer 130 may communicate the information to the patient via email, SMS text message, web page, or other communication channel.

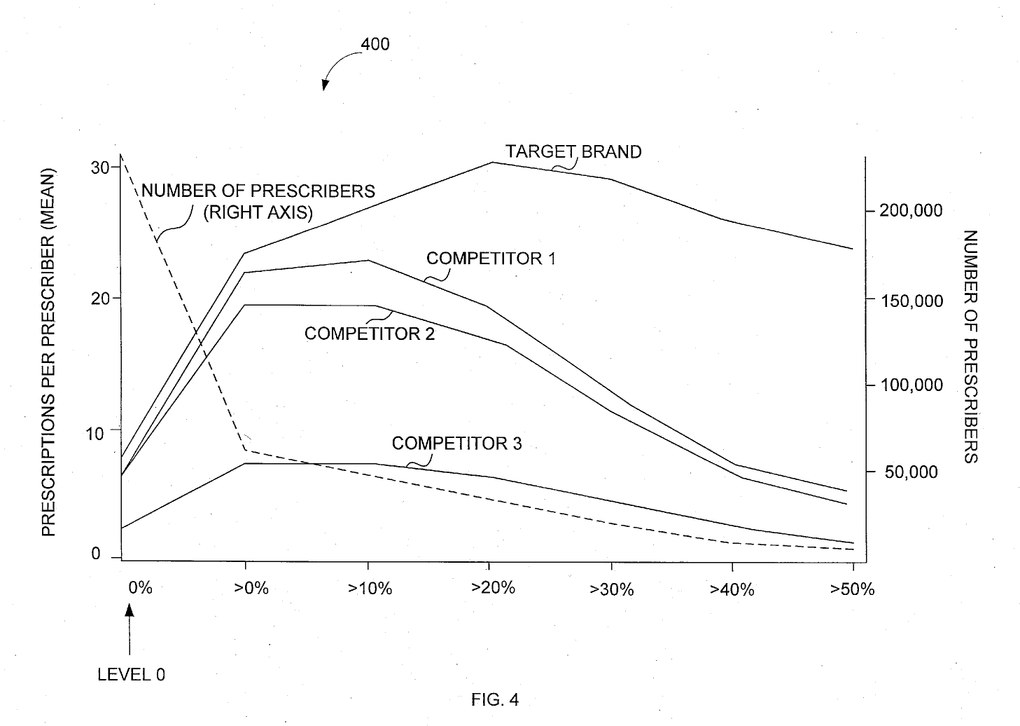

FIG. 4 illustrates an exemplary prescriber profile chart 400, according to an aspect of the invention. Prescriber profile chart 400 compares an average number of prescriptions per prescriber for the Target Brand with the “top 3” Competitors including brands or generics (illustrated in FIG. 4 “Competitor 1” “Competitor 2” and “Competitor 3”) in the same drug class (such as Atypical Antipsychotics). The analysis reviews data over a 6-month period, and illustrates data points for groupings of patients by the “fill share” of a prescriber. The prescriber “fill share” segments group prescribers based on the propensity for their patients to fill scripts for the target brand when given a choice within the category.

As illustrated, Level 0% —reflects the activity associated with prescribers whose patient group (e.g., the patients they see, and prescribe for) fill at least one prescription within the drug class. Level >0%—reflects the activity of all prescribers whose patient group (e.g., the patients they see, and prescribe for) filled at minimum of 10 prescriptions within the category over the 6 months analysis period and who had at least one prescription for the target brand.

In an embodiment, small volume prescribers (whose entire patient group fills less than 10 prescriptions in the category) are excluded from this segment.

Level >10%—reflects the activity of all prescribers whose patient group filled at least 10% of their prescriptions in the drug class for the Target Brand. Level >20%, >30%, >40% & >50% data points reflects similar activity at these percentages of prescriptions in the drug class for the Target Brand.

The right Y axis is a scale of a number of Qualifying Prescribers for each point on the x-axis. The number of prescribers will be highest at Level 0%, and decrease as the prescriber share increases. Note differences between the number of prescribers at Level 0% and Level >0% (the first two points on the graph). This is the difference between the number of prescribers in the category (Level 0%) and the number of prescribers for the brand (Level >0%).

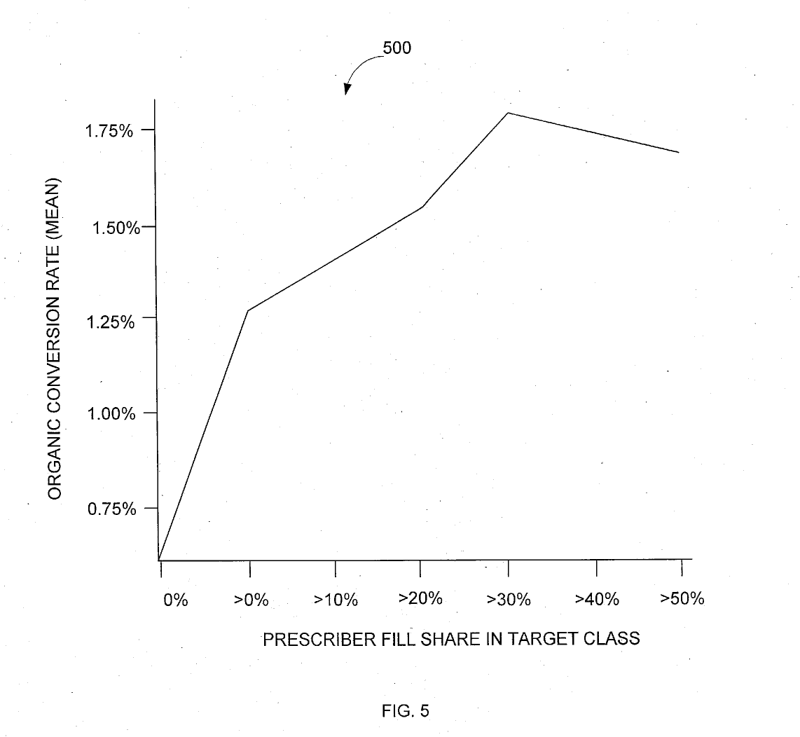

FIG. 5 illustrates an exemplary organic conversion chart 500, according to an aspect of the invention. Organic conversion chart 500 compares the rate at which ‘qualifying patients’ (patients qualify based on a reasonable set of ‘core’ criteria, defined for each brand) demonstrate a fill for the brand during a follow-up period. This may indicate the rate at which patients convert to the brand with no intervention/program. Prescriber-centric programs (e.g., Level >0%) have higher organic conversion rates than programs that are not prescriber-centric (e.g., Level 0%).

The organic conversion calculation may be given by the equation:

N_{PC}/N_{QP}

where N_{PC} is the number of Patient Converters, and N_{QP} is the total number of ‘Qualifying’ Patients

Patient Converters include patients identified as meeting the foundational therapy requirements during a 6 month pre-period (with no pre-period brand use), who demonstrate a fill for the brand during a 5 month post-period.

‘Qualifying’ Patients include patients meeting the foundational therapy requirements during the 6 month pre-period with no pre-period brand use.

TABLE 1
data plotted in organic conversion chart 500.

| | Organic Conversion |
|---|---|
| Fill Share | Rate (mean) |
| 0% | 0.63% |
| >0% | 1.28% |
| >10% | 1.41% |
| >20% | 1.54% |
| >30% | 1.80% |
| >40% | 1.74% |
| >50% | 1.70% |

Level 0%—Reflects the activity associated with all prescribers whose patient group meets ‘qualifying’ criteria for the brand. In an embodiment, there is no prescriber-qualifier based on the patient fills of the brand or category.

Level >0%—Reflects the activity of ‘qualifying patients’ for all prescribers whose patient group filled at minimum of 10 prescriptions within the category over the 6 months analysis period and who had at least one script for the target brand.

In an embodiment, small volume prescribers (whose entire patient group fills less than 10 prescriptions in the drug class) may be excluded from this segment.

Level >10%—Reflects the activity of ‘qualifying’ patients for all prescribers whose patient group filled at least 10% of their scripts in the category (i.e. Atypical Antipsychotics) for the target brand. Level >20%, >30%, >40% & >50% data points reflects similar activity at these levels.

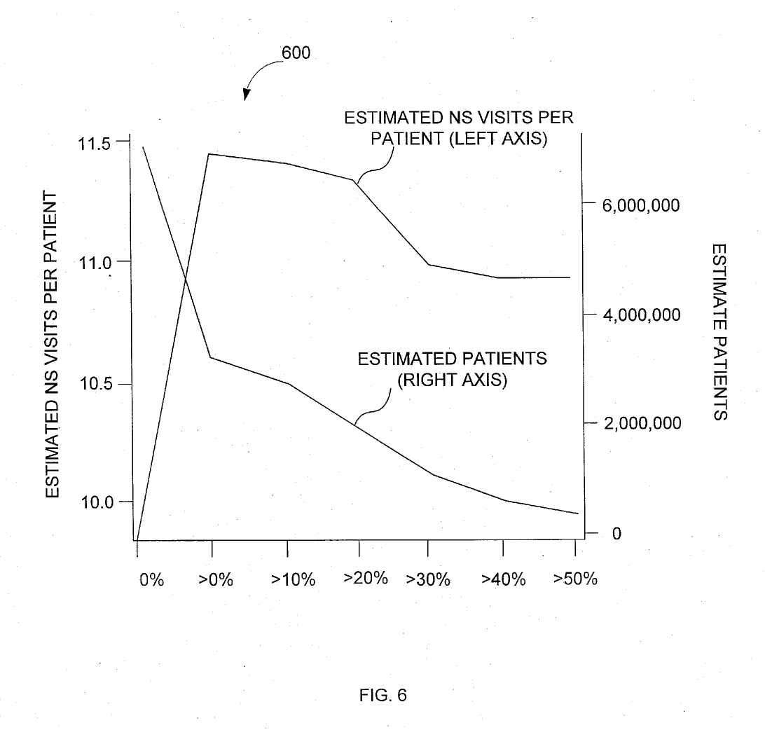

FIG. 6 illustrates an exemplary program size chart 600, according to an aspect of the invention. Program size chart 600 estimates the average number of visits per ‘qualifying’ patient and the total number of unique ‘qualifying’ patients for the program over a 26-week period.

Estimated “Visits per Patient”: counts the total number of distinct dates associated with Rx fill activity (multiple fills on the same date count as “1” visit)

Estimating visits does not qualify based on brand/category fills—patients may fill ANY Rx during a ‘visit’.

Excluded Rx that had a sponsored-print associated with it—to account for ‘typical’ network sponsorship/availability.

To calculate the Maximum, Estimated Print Opportunities for a 26-week program, use the table to multiple the Estimated Patients by the Estimated Visits for the Fill Share Level. For example: at the >0% Fill Share level, multiply 3,225,899 (the Estimated Patients)*11.4 (the Estimated Visits) to =36,775,248 (the Maximum Print Opportunities).

Analysis has ‘built in’ assumption of ‘one print per day’ maximum. Assumes entire network, all states. Purpose is to provide a ‘thumbnail’ size for the opportunity as defined for the initial brand meeting (if brand were to target this group of reasonable, qualifying patients). Once brand has identified interest in/budget available to pursue PCT program—individual programs can be tailored to brand-specific needs/budgets.

TABLE 2
data plotted in program size chart 600.

| | Estimated | Estimated NS Visits |
|---|---|---|
| Fill Share | Patients | per Patient |
| 0% | 7,231,833 | 9.9 |
| >0% | 3,225,899 | 11.4 |
| >10% | 2,741,461 | 11.4 |
| >20% | 1,948,826 | 11.3 |
| >30% | 1,003,736 | 11.0 |
| >40% | 557,335 | 10.9 |
| >50% | 292,037 | 10.9 |

Level 0% —Reflects the activity associated with all prescribers whose patient group meets ‘qualifying’ criteria for the brand. In an embodiment, there is no prescriber-qualifier based on the patient fills of the brand or category.

Level >0%—Reflects the activity of ‘qualifying’ patients for all prescribers whose patient group filled at minimum of 10 prescriptions within the category over the 6 months analysis period and who had at least one script for the target brand.

In an embodiment, small volume prescribers (whose entire patient group fills less than 10 prescriptions in the drug class) may be excluded from this segment.

Level >10%—Reflects the activity of ‘qualifying’ patients for all prescribers whose patient group filled at least 10% of their scripts in the category for the target brand. Similar definition for the >20%, >30%, >40% & >50% data points.

Although described herein as being used to market or promote target brands, other drugs such as generics may be promoted herein as well. Furthermore, those having skill in the art would appreciate that the system and method described herein may be applied to other marketed items such as over-the-counter medications that may be promoted based on an identity/behavior of prescribers.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A method for prescriber-based targeting, comprising:
obtaining, by a computer, information relating to a target drug;
identifying, by the computer, a prescriber to serve as a basis for targeting one or more patients to receive the information relating to the target drug;
determining, by the computer, a patient based on the identified prescriber; and
causing, by the computer, the information relating to the target drug to be communicated to the patient.

2. The method of claim 1, wherein determining the patient based on identified prescriber comprises:
determining, by the computer, a relationship between the patient and the prescriber.

3. The method of claim 2, wherein determining the relationship comprises:
determining, by the computer, that the patient is a current or former patient of the prescriber.

4. The method of claim 1, wherein identifying the prescriber comprises:
determining, by the computer, a number of instances in which the prescriber has prescribed the drug or a drug in a target class, wherein the identification of the prescriber is based on the number.

5. The method of claim 4, wherein the prescriber is identified when the number meets or exceeds a threshold number.

6. The method of claim 4, further comprising:
determining, by the computer, a total number of instances in which the prescriber has prescribed the drug, the drug in the target class and other drugs; and
determining, by the computer, a ratio of the number and the total number, wherein the identification of the prescriber is based on the ratio.

7. The method of claim 6, wherein the ratio comprises a probability that the prescriber will prescribe the drug to the patient, and wherein the prescriber is identified when the probability meets or exceeds a threshold probability.

8. The method of claim 1, wherein identifying the prescriber comprises:
obtaining, by the computer, a prescription record for a prescription written by the prescriber; and
determining, by the computer, an identifier associated with the prescriber from the prescription record.

9. The method of claim 1, wherein identifying the prescriber comprises:
determining, by the computer, an indication of a specialty of the prescriber, wherein the specialty is associated with the drug or drug equivalent, wherein the identification of the prescriber is based on the specialty of the prescriber.

10. The method of claim 1, the method further comprising:
obtaining, by the computer, a patient profile of the patient, wherein the determination that the patient should be targeted is based on the patient profile.

11. A computer for prescriber-based targeting, comprising:
a processor configured to:
obtain information relating to a target drug;
identify a prescriber to serve as a basis for targeting one or more patients to receive the information relating to the target drug;
determine a patient based on the identified prescriber; and
cause the information relating to the target drug to be communicated to the patient.

12. The computer of claim 11, wherein the processor is further configured to:
determine a relationship between the patient and the prescriber.

13. The computer of claim 12, wherein the processor is further configured to:
determine that the patient is a current or former patient of the prescriber.

14. The computer of claim 11, wherein the processor is further configured to:
determine a number of instances in which the prescriber has prescribed the drug or a drug in a target class, wherein the identification of the prescriber is based on the number.

15. The computer of claim 14, wherein the prescriber is identified when the number meets or exceeds a threshold number.

16. The computer of claim 14, wherein the processor is further configured to:
determine a total number of instances in which the prescriber has prescribed the drug, the drug in the target class and other drugs; and
determine a ratio of the number and the total number, wherein the identification of the prescriber is based on the ratio.

17. The computer of claim 16, wherein the ratio comprises a probability that the prescriber will prescribe the drug to the patient, and wherein the prescriber is identified when the probability meets or exceeds a threshold probability.

18. The computer of claim 11, wherein the processor is further configured to:
obtain a prescription record for a prescription written by the prescriber; and
determine an identifier associated with the prescriber from the prescription record.

19. The computer of claim 11, wherein the processor is further configured to:
determine an indication of a specialty of the prescriber, wherein the specialty is associated with the drug or drug equivalent, wherein the identification of the prescriber is based on the specialty of the prescriber.

20. The computer of claim 11, wherein the processor is further configured to:
obtain a patient profile of the patient, wherein the determination that the patient should be targeted is based on the patient profile.
